(19) United States
(12) Patent Application Publication
(10) Pub. No.: US 2014/0268914 A1
(43) Pub. Date: Sep. 18, 2014

(54) METHOD OF CONTROLLING SYNCHRONOUS RECTIFIER FOR POWER CONVERTER, CONTROL CIRCUIT, AND POWER CONVERTER THEREOF

(71) Applicants: Chou-Sheng Wang, Keelung City (TW); Tse-Jen Tseng, Taichung City (TW)

(72) Inventors: Chou-Sheng Wang, Keelung City (TW); Tse-Jen Tseng, Taichung City (TW)

(73) Assignee: SYSTEM GENERAL CORP., New Taipei City (TW)

(21) Appl. No.: 14/217,488

(22) Filed: Mar. 18, 2014

Related U.S. Application Data
(60) Provisional application No. 61/802,786, filed on Mar. 18, 2013.

(51) Int. Cl. H02M 3/335

(52) U.S. Cl. CPC H02M 3/33592
USPC 363/21.13; 363/21.14

(57) ABSTRACT

A method for controlling a synchronous rectifier for a power converter, a control circuit, and a power converter thereof are provided. The method comprises the following steps: turning on a transistor by a rectifier; generating a switching-period signal in accordance with a period of a voltage-sensing signal; generating a turn-on-period signal in accordance with a turned-on period of the rectifier; generating a first disabling signal responding to the switching-period signal; and generating a second disabling signal in response to the turn-on-period signal. The transistor is turned off in response to the first disabling signal and the second disabling signal, and the voltage-sensing signal is related to the switching waveform of a transformer.

### CROSS REFERENCE TO RELATED APPLICATION

This application claims the priority benefits of U.S. provisional application Ser. No. 61/802,786, filed on Mar. 18, 2013. The entirety of the above-mentioned patent application is hereby incorporated by reference herein and made a part of this specification.

### BACKGROUND OF THE INVENTION

1. Field of the Invention

The present invention relates to techniques of controlling a power converter and particularly to a control circuit and methods for controlling a synchronous rectifier (SR) for a flyback power converter that can operate in discontinuous current mode (DCM) and continuous current mode (CCM), wherein the period lock functions provide a reliable and robust approach to prevent the synchronous rectifying (SR) power transistor from backward conduction.

2. Related Art

Power converters have been frequently used for converting an unregulated power source to a constant voltage output. Among various power converters, a flyback power converter is the most common one. A transformer having a primary winding and a secondary winding is the major part of a flyback power converter. The flyback power converter further comprises an output capacitor. The primary winding is connected to the unregulated power source and a switching device is connected to the primary winding to switch on and off the connection between the unregulated power source and the primary winding. A rectifying diode is typically connected to the secondary winding for rectifying the energy transferred from the primary winding into a DC voltage.

The flyback power converter normally has two operation modes, i.e. discontinuous conduction mode (DCM) and continuous conduction mode (CCM). In the discontinuous conduction mode, all the energy stored in the transformer is completely delivered before the next cycle starts. Therefore, no inducted voltage will remain in the transformer to resist the output capacitor discharging back to the transformer. However, when the moment that the switching device is turned off, a current will be discharged from the output capacitor in a reversing direction once the energy stored in the transformer is completely released. In contrast, in the continuous operation mode, some energy remains in the transformer of the flyback power converter. That is, before the current released from the secondary winding drops to zero, the next switching cycle will start. Under the continuous mode operation, the transformer keeps freewheeling the energy when the next switching cycle starts. If the synchronous rectifier of the flyback power converter is not switched off before the next switching cycle starts, the output capacitor will be charged in a reversing direction. The situations described above is known as “backward conduction” of the power converter.

In the disclosures mentioned above, the output capacitor is still sharply charged and discharged via the MOSFET synchronous rectifier (SR) at the switching moment in both continuous mode and discontinuous mode. Therefore, the efficiency is reduced and the noise is increased. Furthermore, in the above approaches, the transformer requires an additional auxiliary winding to generate a driving signal to achieve synchronous rectification, and thus complexity of making transformer is increased.

### SUMMARY OF THE INVENTION

The present invention discloses a method for controlling a synchronous rectifier for a power converter. The method comprises the following steps: turning on a transistor in response to a turned-on period of a rectifier; generating a switching-period signal in accordance with the period of a voltage-sensing signal; generating a turn-on-period signal in accordance with a turned-on period of the rectifier; generating a first disabling signal in response to the switching-period signal; generating a second disabling signal in response to the turn-on-period signal; turning off the transistor in response to the first disabling signal and the second disabling signal. In one embodiment of the present invention, the voltage-sensing signal is related to switching waveforms of a transformer, and the transistor is coupled to the transformer and operated as a synchronous rectifier. The turned-on period of the first disabling signal is shorter than the turned-on period of the switching-period signal. In one embodiment of the present application, the turned-on period of the second disabling signal is shorter than the turned-on period of the turn-on-period signal.

From another point of view, the present invention discloses a controlling method for a synchronous rectifier of a power converter. The controlling method comprises the following steps: turning on a transistor in response to a turned-on period of a rectifier; turning off the transistor responding to the turned-on period of a switching waveform of a transformer; turning off the transistor responding to a turned-on period of the rectifier. The transistor is coupled to the transformer and parallel connected to the rectifier, and operates for synchronous rectification. A turned-on period of the transistor is shorter than the turned-on period of the switching waveform of the transformer, and is also shorter than the turned-on period of the rectifier.

From another point of view, the present invention discloses a control circuit of the power converter for controlling synchronous rectification of a power converter. The power converter comprises a transformer, a transistor, a rectifier, and a control circuit. According to the present invention, the transistor is coupled to the rectifier and operates for synchronous rectification. The control circuit is coupled to the transistor, and is configured to turn on the transistor responding to turning-on of the rectifier, generate a switching-period signal in accordance with the period of a voltage-sensing signal, generate a turn-on-period signal in accordance with a turned-on period of the rectifier, generate a first disabling signal in response to the switching-period signal, generate a second disabling signal in response to the turn-on-period signal, and turn off the transistor responding to the first disabling signal and the second disabling signal. The voltage-sensing signal is related to a switching waveform of the transformer. The turned-on period of the first disabling signal is shorter than the turned-on period of the switching-period signal, and is also shorter than the turned-on period of the turn-on-period signal.

From another point of view, the present invention discloses a power converter, which comprising a transformer, a rectifier, a transistor, and a control circuit. The transistor is coupled to the rectifier, and the rectifier is parallel connected to the transistor. The control circuit is coupled to the transistor, and the control circuit turns on the transistor responding to turning-on of the rectifier, turns off the transistor responding to a turned-on period of a switching waveform of a transformer, and turns off the transistor responding to a turned-on period of the rectifier. The turned-on period of the transistor is shorter than the turned-on period of the switching waveform of the transformer, and the turned-on period of the transistor is shorter than the turned-on period of the rectifier.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 shows a schematic diagram illustrating a flyback power converter with synchronous rectifier (SR) according to one embodiment of the present invention

FIG. 2 shows a block diagram illustrating a control circuit according to one embodiment of the present invention.

FIG. 3 shows a block diagram illustrating a SR-reset circuit according to one embodiment of the present invention.

FIG. 4 shows the waveforms of the flyback power converter operated in DCM according to one embodiment of the present invention.

FIG. 5 shows the waveforms of the flyback power converter operated in CCM according to one embodiment of the present invention.

FIG. 6 shows a circuit diagram illustrating a switching-period lock circuit according to one embodiment of the present invention.

FIG. 7 shows a circuit diagram illustrating a turn-on-period lock circuit according to one embodiment of the present invention.

FIG. 8 shows a reference circuit diagram illustrating one of the pulse generators in FIGS. 6 and 7 according to one embodiment of the present invention.

FIG. 9 shows the waveform of the pulse generator according to one embodiment of the present invention.

FIG. 10 shows a flowchart illustrating a method of controlling a synchronous rectifier for a power converter according to one embodiment of the present invention.

FIG. 11 shows a flowchart illustrating a control method for the synchronous rectifier of the power converter according to one embodiment of the present invention.

### DETAILED DESCRIPTION OF EMBODIMENTS

The present invention provides a control circuit and methods of synchronous rectifier (SR) with period lock functions for a flyback power converter that can operate in DCM (discontinuous current mode) and CCM (continuous current mode). The period lock functions for the flyback power converter provide a reliable and robust approach to prevent a synchronous rectifying transistor from backward conduction.

The DCM operation means a transformer of the power converter is fully demagnetized before the transformer is re-magnetized (a start of the next switching cycle). The CCM operation means the transformer of the power converter is not fully demagnetized in the start of the next switching cycle.

FIG. 1 shows a schematic diagram illustrating a flyback power converter with synchronous rectifier (SR) according to one embodiment of the present invention. The flyback power converter comprises a transformer 10, a pulse width modulation (PWM) controller 20, transistors 25 and 30, a rectifier 40, an output capacitor 45, resistors 51 and 52, and a control circuit 100. The rectifier 25 operates for synchronous rectification of the power converter. The transistor 25 is configured to switch the primary-winding of the transformer 10 for transferring the energy from input V_{IN} to the output V_{O} of the flyback power converter. A signal V_{DS} is generated between the transistor 25 and primary-winding of the transformer 10. The PWM controller 20 is configured to detect the output V_{O} for generating a switching signal S_{W} to control the transistor 25 and regulate the output V_{O}. When the rectifier 40 (or the body diode of a transistor 30) is turned on for delivering the power from the transformer 10 to the output capacitor 45, the transistor 30 will be turned on to reduce the conduction loss of the rectifier 40 (the forward voltage drop of the rectifier 40). The control circuit 100 generates a control signal S_{SR} to drive the transistor 30 for the synchronous rectifying operation. The resistors 51 and 52 are coupled to the secondary-winding of the transformer 10 for generating a voltage-sensing signal V_{S} in according to the waveform of the transformer 10. The voltage-sensing signal V_{S} is coupled to the control circuit 100 for generating the control signal S_{SR}.

FIG. 2 shows a block diagram illustrating the control circuit 100 according to one embodiment of the present invention. The control circuit 100 comprises a comparator 110, a flip-flip 120, an inverter 121, an AND gate 125, and a SR-reset circuit 150. The comparator 110 generates an enable signal S_{E} when the voltage-sensing signal V_{S} is lower than a low-level threshold V_{TL}. The rising edge of the enable signal S_{E} is configured to set (enable) the flip-flip 120. The output of the flip-flop 120 and the enable signal S_{E} are connected to the AND gate 125 to generate the control signal S_{SR}. The SR-reset circuit 150 is configured to receive the enable signal S_{E}, the voltage-sensing signal V_{S} and the control signal S_{SR} for generating a disable signal S_{D}. Through the inverter 121, the disable signal S_{D} is configured to reset the flip-flop 120 and disable the control signal S_{SR}. The signal ENB of the flip-flop 120 is constantly high.

When the rectifier 40 is conducted, the voltage-sensing signal V_{S} will be lower than the low-level threshold V_{TL}. Therefore, the control signal S_{SR} will be enabled to turn on the transistor 30 while the rectifier 40 is conducted. The control signal S_{SR} will be disabled responding to the voltage-sensing signal V_{S}, the control signal S_{SR} and the enable signal S_{E}. The voltage-sensing signal V_{S} is related to the waveform of the transformer 10.

FIG. 3 shows a block diagram illustrating the SR-reset circuit 150 according to one embodiment of the present invention. The SR-reset circuit 150 comprises a comparator 160, an OR gate 170, a switching-period lock circuit 200, and a turn-on-period lock circuit 300. The comparator 160 generates a switching-period signal S_{T} when the voltage-sensing signal V_{S} is higher than a high-level threshold V_{TH}. The switching-period signal S_{T} is configured to generate a first disabling signal S_{D1} through the switching-period lock circuit 200. The control signal S_{SR} and the enable signal S_{E} are configured to generate a second disabling signal S_{D2} through the turn-on-period lock circuit 300. Both the first disabling signal S_{D1} and the second disabling signal S_{D2} are coupled to the OR gate 170 to generate the disable signal S_{D}.

FIG. 4 shows the waveforms of the flyback power converter operated in DCM according to one embodiment of the present invention. The signal V_{DS} is generated between the transistor 25 and primary-winding of the transformer 10 in FIG. 1. The period T is the switching period of the switching signal S_{W}. The on-time T_{ON} represents the turned-on period (conduction period) of the rectifier 40, and the turned-on period of the rectifier 40 is correlated to the demagnetizing time of the transformer 10. The second disabling signal S_{D2} is generated to disable the control signal Sₛᵢₜ before the end of the turned-on period of the rectifier 40.

FIG. 5 shows the waveforms of the flyback power converter operated in CCM according to one embodiment of the present invention. The on-time T_{ON} represents the turned-on period (conduction period) of the rectifier 40, and the on-time T_{ON} is ended responding to the start of the switching signal S_{W} (the start of the next switching cycle). The first disabling signal S_{D1} is generated to disable the control signal S_{SR} before the start of the next switching cycle.

FIG. 6 shows a circuit diagram illustrating a switching-period lock circuit 200 according to one embodiment of the present invention. The switching-period lock circuit 200 comprises a first pulse generator 210, a second pulse generator 215, a third pulse generator 265, an inverter 211, a power transistor 220, a current source 230, capacitors 235 and 245, a switch 240, a buffer amplifier 250 and resistors 251, 252. The current source 230 is coupled to the power transistor 220, the capacitor 235, and the switch 240, and the current source 230 is applied to charge the capacitor 235. The second pulse generator 215 receives the output of the first pulse generator 210 through the inverter 211. The output of the second pulse generator 215 is coupled to the control node of the power transistor 220, the first node of the power transistor 220 is coupled to the current source 230, and the second node of the power transistor 220 is coupled to the ground. The switch 240 is configured to sample the voltage of the capacitor 235 to the capacitor 245 controlled by an output of the pulse generator 210. The switching-period signal S_{T} generates a pulse signal through the pulse generator 210. The output of the pulse generator 210 is configured to turn on the switch 240 for the sampling responding to the rising edge of the switching-period signal S_{T}. The output of the pulse generator 210 is further configured to discharge the capacitor 235 after the sampling through the inverter 211, the pulse generator 215 and the power transistor 220. The voltage level V₂₄₅ of the capacitor 245 is related to the period T of the switching signal S_{W} (i.e., the switching-period signal S_{T}), and the voltage level V₂₄₅ can be calculated by the formula (1) in accordance with the current I₂₃₀ of the current source 230 and the capacitance C₂₃₅ of the capacitor 235.

$${V}_{245} = \frac{{I}_{230}}{{C}_{235}} \times T \qquad ( 1 )$$

The capacitor 245 is configured to generate an attenuated signal V_{F1} through the buffer amplifier 250 and the resistors 251 and 252. The comparator 260 is configured to generate the first disabling signal S_{D1} through the pulse generator 265 when the voltage level of the capacitor 235 is higher than the attenuated signal V_{F1}. Therefore, the first disabling signal S_{D1} will be generated before the switching signal S_{W} is enabled (before the start of the next switching cycle).

FIG. 7 shows a circuit diagram illustrating a turn-on-period lock circuit 300 according to one embodiment of the present invention. The turn-on-period lock circuit 300 comprises pulse generators 310, 315, 365, and 380, a flip-flop 370, inverters 311, 371, and 372, an current source 330, capacitors 335 and 345, an power transistor 320, a switch 340, a buffer amplifier 350 and resistors 351 and 352. The rising edge of the control signal S_{SR} is configured to generate a turn-on-period signal S_{ON} in the flip-flop 370. The enable signal S_{E} is configured to reset the flip-flop 370 and disable the turn-on-period signal S_{ON} through the inverters 371, 372 and the pulse generator 380 when the enable signal S_{E} is disabled (logic-low; the rectifier 40 is not conducted).

The current source 330 is coupled to the power transistor 320, the capacitor 335, and the switch 340, and the current source 330 is applied to charge the capacitor 335. The switch 340 is configured to sample the voltage of the capacitor 335 to the capacitor 345 controlled by an output of the pulse generator 310. The turn-on-period signal S_{ON} generates a pulse signal via the pulse generator 310. The output of the pulse generator 310 is configured to turn on the switch 340 for the sampling responding to the rising edge of the turn-on-period signal S_{ON}. The output of the pulse generator 310 is further configured to discharge the capacitor 335 after the sampling through the inverter 311, the pulse generator 315 and the power transistor 320. The output of the second pulse generator 315 is coupled to the control node of the power transistor 320. The voltage level of the capacitor 345 will be related to the on-time T_{ON} (conduction period) of the rectifier 40, and the voltage level V₃₄₅ can be calculated by the formula (2) in accordance with the current I₃₃₀ of the current source 330 and the capacitance C₃₃₅ of the capacitor 335.

$${V}_{345} = \frac{{I}_{330}}{{C}_{335}} \times {T}_{ON} \qquad ( 2 )$$

The capacitor 345 is configured to generate an attenuated signal V_{F2} through the buffer amplifier 350 and the resistors 351 and 352. The comparator 360 is configured to generate the second disabling signal S_{D2} through the pulse generator 365 when the voltage level of the capacitor 335 is higher than the attenuated signal V_{F2}. Therefore, the second disabling signal S_{D2} will be generated before the conduction time of the rectifier 40 ends, that is, at the end of the on-time T_{ON}.

FIG. 8 shows a reference circuit diagram illustrating one of the pulse generators in FIGS. 6 and 7 according to one embodiment of the present invention. The pulse generator shown in FIG. 8 comprises a current source 410, inventors 411 and 420, the transistor 412, an AND gate 425, and a capacitor 415. The input signal X is received by the transistor 412 through the inventor 411. The current source 410 is configured to charge the capacitor 415. The voltage level of the capacitor 415 is inverted by the inventor 420. The transistor 412 is configured to discharge the capacitor 415 controlled by the input signal X. The input signal X and the inverted voltage level of the capacitor 415 is received by the AND gate 425 to generate an output signal Y.

FIG. 9 shows the waveform of the pulse generator according to one embodiment of the present invention. The output signal Y of the pulse generator will generate a pulse in responding to the rising edge of the input signal X of the pulse generator. The pulse width of the output signal Y is determined by the current of the current source 410 and the capacitance of the capacitor 415 shown in FIG. 8.

Therefore, the transistor 30 shown in FIG. 1 is turned on responding to the turn on of the rectifier 40. The switching-period signal S_{T} is generated in accordance with the period of the voltage-sensing signal V_{S}. The turn-on-period signal S_{ON} is generated in accordance with the turned-on period of the rectifier 40. The first disabling signal S_{D1} is generated responding to the switching-period signal S_{T}. A second disabling signal S_{D2} is generated responding to the turn-on-period signal S_{ON}. The transistor 30 is tuned off responding to the first disabling signal and the second disabling signal. The period of the first disabling signal S_{D1} is shorter than the period of the switching-period signal S_{T}. The period of the second disabling signal S_{D2} is shorter than the period of the turn-on-period signal SON.

FIG. 10 shows a flowchart illustrating a method of controlling a synchronous rectifier for a power converter according to one embodiment of the present invention. In the present embodiment, the method of controlling the synchronous rectifier for the power converter is applicable to the power converter of FIGS. 1-3. Each step of the method is described herein. Referring to FIGS. 1-3 and FIG. 10, in step S1010, the control circuit 100 turns on the transistor 30 responding to a turned-on of the rectifier 40 (the body diode of a transistor 30). In step S1020, the control circuit 100 generates the switching-period signal S_{T} (i.e., switching signal S_{W}) in accordance with the period of the voltage-sensing signal V_{S}. In step S1030, the control circuit 100 generates the turn-on-period signal S_{ON} in accordance with the turn on period (i.e., the conduction period) T_{ON} of the rectifier 40. In step S1040, the control circuit 100 generates the first disabling signal S_{D1} responding to the switching-period signal S_{T} (i.e., switching signal S_{W}). In step S1050, the control circuit 100 generates the second disabling signal S_{D2} responding to the turn-on-period signal S_{ON}. In step S1060, the control circuit 100 turns off the transistor 30 responding to the first disabling signal S_{D1} and the second disabling signal S_{D2}. The voltage-sensing signal V_{S} is related to the switching waveform of the transformer 10. The transistor 30 is coupled to the transformer 10 and operated as the synchronous rectifier. The rectifier 40 is parallel connected to the transistor 30. The turned-on period of the first disabling signal S_{D1} is shorter than the turned-on period of the switching-period signal S_{T} (i.e., switching signal S_{W}). The turned-on period of the second disabling signal S_{D2} is shorter than the turned-on period of the turn-on-period signal S_{ON}. The techniques combined with detailed actuation of the method of controlling the synchronous rectifier for the power converter are described in the above embodiments of the present invention.

In another point of view, FIG. 11 shows a flowchart illustrating a control method for the synchronous rectifier of the power converter according to one embodiment of the present invention. In the present embodiment, the control method for the synchronous rectifier of the power converter is applicable to the power converter of FIGS. 1-3. Each step of the method is described herein. In step S1110, the control circuit 100 turns on the transistor 30 responding to a turned-on period of the rectifier 40 (the body diode of a transistor 30). In step S1120, the control circuit 100 turns off the transistor 30 responding to the period of the switching waveform of the transformer 10. In step S1130, the control circuit 100 turns off the transistor 10 responding to the turned-on period of the rectifier 40. The transistor 30 is coupled to the transformer 10 and operated as the synchronous rectifier. The rectifier 40 is parallel connected to the transistor 30. The turn on period of the transistor 30 is shorter than the period of the switching waveform of the transformer 10, and the turn on period of the transistor 30 is shorter than the turned-on period of the rectifier 40.

Although the present invention and the advantages thereof have been described in detail, it should be understood that various changes, substitutions, and alternations can be made therein without departing from the spirit and scope of the invention as defined by the appended claims. That is, the discussion included in this invention is intended to serve as a basic description. It should be understood that the specific discussion may not explicitly describe all embodiments possible; many alternatives are implicit. The generic nature of the invention may not fully explained and may not explicitly show that how each feature or element can actually be representative of a broader function or of a great variety of alternative or equivalent elements. Again, these are implicitly included in this disclosure. Neither the description nor the terminology is intended to limit the scope of the claims.

What is claimed is:

1. A method for controlling a synchronous rectifier of a power converter, comprising:
turning on a transistor responding to a turned-on period of a rectifier;
generating a switching-period signal in accordance with a period of a voltage-sensing signal;
generating a turn-on-period signal in accordance with a turned-on period of the rectifier;
generating a first disabling signal responding to the switching-period signal;
generating a second disabling signal responding to the turn-on-period signal; and
turning off the transistor responding to the first disabling signal and the second disabling signal,
wherein the voltage-sensing signal is related to switching waveforms of a transformer; the transistor is coupled to the transformer and operated as a synchronous rectifier; a period of the first disabling signal is shorter than a period of the switching-period signal; a period of the second disabling signal is shorter than a period of the turn-on-period signal.

2. The method as claimed in claim 1, in which a switching signal is configured to switch the transformer for regulating an output of the power converter; the switching waveform is correlated to the switching signal; the turned-on period of the turn-on-period signal is not overlap to a turned-on period of the switching signal; the turned-on period of the first disabling signal and the turned-on period of the second disabling signal are set between the turned-on period of the turn-on-period signal and the turned-on period of the switching signal.

3. The method as claimed in claim 1, in which a control signal is configured to control the transistor; the control signal is enabled responding to the turned-on period of the rectifier; the control signal is disabled responding to the first disabling signal and the second disabling signal.

4. The method as claimed in claim 1, in which the voltage-sensing signal is detected by detecting a waveform of the transformer.

5. The method as claimed in claim 1, in which the rectifier is a body diode of the transistor.

6. The method as claimed in claim 1, in which the first disabling signal is generated by a switching-period lock circuit; the switching-period lock circuit is configured to detect a waveform of the transformer through a resistor.

7. The method as claimed in claim 1, in which the second disabling signal is generated by a turn-on-period lock circuit; the turn-on-period lock circuit is configured to detect a waveform of the rectifier through a resistor.

8. A controlling method for a synchronous rectifier of a power converter, comprising:
turning on a transistor responding to a turned-on period of a rectifier;
turning off the transistor responding to a period of a switching waveform of a transformer; and
turning off the transistor responding to a turned-on period of the rectifier,
wherein the transistor is coupled to the transformer and parallel connected to the rectifier, and operates for synchronous rectification; a turn-on period of the transistor is shorter than a period of the switching waveform of the transformer, and is also shorter than the turned-on period of the rectifier.

9. The control method as claimed in claim 8, in which a switching signal is configured to switch the transformer for regulating an output of the power converter; the switching waveform is correlated to the switching signal; the turned-on period of the turn-on-period signal is not overlap to a turned-on period of the switching signal; the turned-on period of the first disabling signal and the turned-on period of the second disabling signal are set between the turned-on period of the turn-on-period signal and the turned-on period of the switching signal.

10. The control method as claimed in claim 8, in which a control signal is configured to control the transistor; the control signal is enabled responding to the turn-on of the rectifier; the control signal is disabled responding to the period of the switching waveform of the transformer.

11. The control method as claimed in claim 8, in which a control signal is configured to control the transistor; the control signal is enabled responding to the turn-on of the rectifier; the control signal is disabled responding to the turned-on period of the rectifier.

12. The control method as claimed in claim 8, in which the rectifier is a body diode of the transistor.

13. The control method as claimed in claim 8, in which the period of the switching waveform of the transformer is determined by a switching-period lock circuit; the switching-period lock circuit is configured to detect a waveform of the transformer through a resistor.

14. The control method as claimed in claim 8, in which the turned-on period of the rectifier is determined by a turn-on-period lock circuit; the turn-on-period lock circuit is configured to detect a waveform of the rectifier through a resistor.

15. A power converter, comprising:
a transformer;
a rectifier;
a transistor coupled to the rectifier, and operates for synchronous rectification; and
a control circuit coupled to the transistor, and configured to turn on the transistor responding to turning-on of the rectifier, the control circuit comprising:
a first comparator, for generating an enable signal in accordance with a voltage-sensing signal;
a SR-reset circuit, for generating a switching-period signal in accordance with a voltage-sensing signal, generating a turn-on-period signal in accordance with a turned-on period of the rectifier, generating a first disabling signal responding to the switching-period signal, generating a second disabling signal responding to the turn-on-period signal, and generating a disable signal in accordance with the first disabling signal and the second disabling signal; and
a flip-flop and an AND gate, wherein the disable signal is coupled to a reset end of the flip-flop, the flip-flop is set by the enable signal, an output of the flip-flop and the enable signal are connected to the AND gate to generate a control signal for controlling the transistor,
wherein the voltage-sensing signal is related to a switching waveform of the transformer; a turned-on period of the first disabling signal is shorter than a turned-on period of the switching-period signal; a turned-on period of the second disabling signal is shorter than a turned-on period of the turn-on-period signal; the turned-on period of the turn-on-period signal is not overlap to the turned-on period of the first disabling signal and the turned-on period of the second disabling signal.

16. The power converter as claimed in claim 15, in which the SR-reset circuit comprising:
a second comparator for generating the switching-period signal in accordance with a period of the voltage-sensing signal and a high-level threshold;
a turn-on-period lock circuit for generating the turn-on-period signal in accordance with the turned-on period of the rectifier and the control signal, and generating a second disabling signal responding to the turn-on-period signal;
a switching-period lock circuit for generating a first disabling signal responding to the switching-period signal; and
an OR gate for generating the enable signal to turn off the transistor responding to the first disabling signal and the second disabling signal.

17. A power converter, comprising:
a transformer;
a rectifier;
a transistor coupled to the rectifier, and the rectifier operates for synchronous rectification; and
a control circuit coupled to the transistor, the control circuit turns on the transistor responding to turning-on of the rectifier, turns off the transistor responding to a turning-on period of a switching waveform of a transformer, and turns off the transistor responding to a turned-on period of the rectifier,
wherein a turned-on period of the transistor is shorter than the turned-on period of the switching waveform of the transformer; the turned-on period of the transistor is shorter than the turned-on period of the rectifier.

18. A control circuit of a power converter, for controlling synchronous rectification of the power converter, comprising:
a first comparator, for generating an enable signal in accordance with a voltage-sensing signal;
a SR-reset circuit, for generating a switching-period signal in accordance with a voltage-sensing signal, generating a turn-on-period signal in accordance with a turned-on period of the rectifier, generating a first disabling signal responding to the switching-period signal, generating a second disabling signal responding to the turn-on-period signal, and generating a disable signal in accordance with the first disabling signal and the second disabling signal; and
a flip-flop and an AND gate, wherein the disable signal is coupled to a reset end of the flip-flop, the flip-flop is set by the enable signal, an output of the flip-flop and the enable signal are connected to the AND gate to generate a control signal for controlling the transistor,
wherein the voltage-sensing signal is related to a switching waveform of the transformer; a turned-on period of the first disabling signal is shorter than a turned-on period of the switching-period signal; a turned-on period of the second disabling signal is shorter than a turned-on period of the turn-on-period signal; the turned-on period of the turn-on-period signal is not overlap to the turned-on period of the first disabling signal and the turned-on period of the second disabling signal.

19. The control circuit as claimed in claim 18, in which the SR-reset circuit comprising:
a second comparator for generating the switching-period signal in accordance with a period of the voltage-sensing signal and a high-level threshold;
a turn-on-period lock circuit for generating the turn-on-period signal in accordance with the turned-on period of the rectifier and the control signal, and generating a second disabling signal responding to the turn-on-period signal;
a switching-period lock circuit for generating a first disabling signal responding to the switching-period signal; and
an OR gate for generating the enable signal to turn off a transistor of the a power converter responding to the first disabling signal and the second disabling signal.

20. The control circuit as claimed in claim 19, in which the switching-period lock circuit comprising:
a first pulse generator, a second pulse generator, a third pulse generator, a power transistor, a switch, a current source, a capacitor, and a comparator, wherein the current source is coupled to the power transistor, a capacitor, and the switch, the current source is applied to charge the capacitor;
the second pulse generator is configured to receive an output of the first pulse generator through an inverter, and an output of the second pulse generator is coupled to an control node of the power transistor, wherein an first node of the power transistor is coupled to the current source;
the switch is configured to sample a voltage of the capacitor controlled by an output of the first pulse generator;
wherein the first pulse generator receives the switching-period signal to generate a pulse signal, an output of the first pulse generator is configured to turn on the switch for the sampling responding to the rising edge of the switching-period signal; and
the comparator configured to generate the first disabling signal through the third pulse generator when the voltage level of the capacitor is higher than an attenuated signal.

21. The control circuit as claimed in claim 19, in which the turn-on-period lock circuit comprising:
a flip-flop for generating a turn-on-period signal in accordance with a rising edge of the control signal;
a power transistor, a first capacitor and a second capacitor, a switch;
a current source coupled to a first node of the power transistor, a first capacitor, and the switch, wherein the switch is configured to sample a voltage of the first capacitor to the second capacitor controlled by an output of the first pulse generator;
an output of the first pulse generator is configured to turn on the switch for sampling responding to a rising edge of the turn-on-period signal, and discharge the first capacitor after sampling through the second pulse generator and the power transistor;
an output of the second pulse generator is coupled to a control node of the power transistor; and
the comparator for generating the second disabling signal through the third pulse generator.
